(19) United States
(12) Patent Application Publication
(10) Pub. No.: US 2014/0046989 A1
(43) Pub. Date: Feb. 13, 2014

(54) SYSTEMS AND METHODS FOR DUAL NUMBER BASE CALCULATORS

(71) Applicant: Van S. CHANDLER, Georgetown, TX (US)

(72) Inventor: Van S. CHANDLER, Georgetown, TX (US)

(73) Assignee: Infinite Response, Inc.

(21) Appl. No.: 13/572,548

(22) Filed: Aug. 10, 2012

(51) Int. Cl. G06F 15/02

(52) U.S. Cl. 708/130

(57) ABSTRACT

Calculators, methods, and non-transitory machine-readable mediums for convergence of a variety of communication sources are presented. More particularly, embodiments relate to a dual number base calculator. In various embodiments, the calculator may include a first graphical or numerical display; a second graphical or numerical display; a first block of keys for accepting input according to a first number base; a second block of keys for accepting input according to a different number base; and a processor for performing a mathematical operation based on input from the first and second blocks of keys. The first and second blocks of keys may be available for input at the same time. The processor may be configured to show a result of the mathematical operation on the first and second graphical or numerical displays at the same time, the result shown on the first graphical or numerical display according to the first number base and on the second graphical or numerical display according to the different number base.

### SUMMARY

One specific embodiment relates to a dual number base calculator. The calculator may include a first graphical or numerical display; a second graphical or numerical display; a first block of keys for accepting input according to a first number base; a second block of keys for accepting input according to a different number base; and a processor for performing a mathematical operation based on input from the first and second block of keys. The first and second blocks of keys may be available for input at the same time. The processor may be configured to show a result on the first graphical or numerical display at the same time as on the second graphical or numerical display, the result shown on the first graphical or numerical display according to the first number base and on the second graphical or numerical display according to the different number base.

According to some embodiments of the calculator, the first and second blocks of keys are available for input at the same time without requiring any action from an operator.

In some embodiments, the calculator may further include a first side and a second side. The first side may be dedicated to the first number base including the first block of keys. The second side may be dedicated to the different number base including the second block of keys. The first side may be different from the second side.

Some further embodiments of the calculator include a third block of keys including at least one bitwise operator.

According to some embodiments of the calculator, the first block of keys has a first color and the second block of keys has a second color, the first and second colors being different.

In some embodiments of the calculator, the first and second graphical or numerical displays show an operations history in the first number base and the different number base, respectively. According to some embodiments, the operations history is shown on multiple lines.

In some embodiments of the calculator, the first and second graphical or numerical displays are horizontally aligned. According to some embodiments, the first and second graphical or numerical displays are horizontally aligned when they are in an intended viewing position.

According to some embodiments of the calculator, the first number base is base 16 and the different number base is base 10. In some further embodiments, the first and second graphical or numerical displays are horizontally aligned such that the first graphical or numerical display corresponding with base 16 is left of the second graphical or numerical display corresponding with base 10.

According to some embodiments of the calculator, the mathematical operation may be a calculation. In some embodiments, the mathematical operation includes at least one of adding, subtracting, multiplying, dividing, AND, OR, XOR, NAND, and modulo. According to some embodiments, the mathematical operation includes converting from a first data type to a different data type.

In some embodiments of the calculator, the result is shown on the first and second graphical or numerical displays at the same time automatically upon completion of the mathematical operation.

According to some embodiments of the calculator, the calculator is about 160 mm long by about 120 mm wide.

Another specific embodiment relates to a non-transitory machine-readable storage medium encoded with instructions for showing number base conversions of calculated numbers. The instructions may include code for: accepting input from a first set of keys according to a first number base or from a second set of keys according to a different number base; performing a mathematical operation based on the input; and showing a result of the mathematical operation in a first display area, while showing an equivalent result at the same time according to the different number base on a second display area. The first set of keys and the second set of keys may be available for input at the same time.

Some further embodiments of the non-transitory machine-readable storage medium include a third set of keys including at least one bitwise operator.

According to some embodiments of the non-transitory machine-readable storage medium, the first set of keys has a first color and the second set of keys has a second color, the first and second colors being different.

In some embodiments of the non-transitory machine-readable storage medium, the first and second display areas show an operations history in the first number base and the different number base, respectively. According to some embodiments, the operations history is shown on multiple lines.

In some embodiments of the non-transitory machine-readable storage medium the first and second display areas are horizontally aligned.

According to some embodiments of the non-transitory machine-readable storage medium, the first number base is base 16 and the different number base is base 10. In some further embodiments, the first and second graphical or numerical displays are horizontally aligned such that the first graphical or numerical display corresponding with base 16 is left of the second graphical or numerical display corresponding with base 10.

In some embodiments of the non-transitory machine-readable storage medium, the result is shown on the first and second display areas at the same time automatically upon completion of the mathematical operation.

According to some embodiments of the non-transitory machine-readable storage medium, the first and second graphical or numerical display areas are each about 96 pixels wide and about 96 pixels high.

According to some embodiments of the non-transitory machine-readable storage medium, the mathematical operation may be a calculation. In some embodiments, the mathematical operation includes at least one of adding, subtracting, multiplying, dividing, AND, OR, XOR, NAND, and modulo. According to some embodiments, the mathematical operation includes converting from a first data type to a different data type.

Yet another specific embodiment relates to a method of performing a mathematical operation according to a first number base or a different number base. The method may include: accepting input from a first set of buttons according to the first number base or from a second set of buttons according to the different number base; performing the mathematical operation; and showing a result of the mathematical operation in a first graphical or numerical display area and a second graphical or numerical display area at the same time, the result shown in the first graphical or numerical display area according to the first number base and the second graphical or numerical display area showing an equivalent result according to the different number base. In some embodiments, the first set of buttons and the second set of buttons are available for input at the same time.

Some further embodiments of the method include: showing a first operations history in the first number base and a second operations history in the different number base. Another further embodiment of the method includes: a third set of buttons including at least one bitwise operator.

According to some embodiments of the method, the first set of buttons has a first color and the second set of buttons has a second color, the first and second colors being different.

In some embodiments of the method, the first and second graphical or numerical display areas show an operations history in the first number base and the different number base, respectively. According to some embodiments, the operations history is shown on multiple lines.

According to some embodiments of the method, the first and second graphical or numerical display areas are horizontally aligned. In some embodiments, first and second graphical or numerical display areas are horizontally aligned when they are in an intended viewing position.

In some embodiments of the method, the first number base is base 16 and the different number base is base 10. In some further embodiments, the first and second graphical or numerical displays are horizontally aligned such that the first graphical or numerical display corresponding with base 16 is left of the second graphical or numerical display corresponding with base 10.

According to some embodiments of the method, the result is shown on the first and second graphical or numerical displays at the same time automatically upon completion of the mathematical operation.

According to some embodiments of the method, the mathematical operation may be a calculation. In some embodiments, the mathematical operation includes at least one of adding, subtracting, multiplying, dividing, AND, OR, XOR, NAND, and modulo. According to some embodiments, the mathematical operation includes converting from a first data type to a different data type.

Still another specific embodiment relates to a type-casting calculator. The calculator may include: a graphical or numerical display; a block of numerical keys for specifying at least one number; a block of data type keys for specifying at least one data type; a processor for performing a type cast based on input from the block of numerical keys and the block of at least one data type key. The processor may be configured to show a result of the type cast on the graphical or numerical display.

According to some embodiments of the type-casting calculator, the processor may be further configured to perform a mathematical operation. In some embodiments, the mathematical operation may be a calculation. In some embodiments, the mathematical operation includes at least one of adding, subtracting, multiplying, dividing, AND, OR, XOR, NAND, and modulo.

Some further embodiments of the type-casting calculator include a bitwise operation block of keys including at least one bitwise operator.

In some embodiments of the type-casting calculator, the graphical or numerical display shows an operations history. According to some embodiments, the operations history is shown on multiple lines.

According to some embodiments of the type-casting calculator, the calculator is about 160 mm long by about 120 mm wide.

Another specific embodiment relates to a non-transitory machine-readable storage medium encoded with instructions for showing a type cast of a number. The instructions may include code for: accepting input from a set of numerical keys for specifying at least one number and a set of at least one data type key for specifying at least one data type; performing the type cast based on the input; and showing a result of the type cast in a display area.

Some further embodiments of the non-transitory machine-readable storage medium include a set of at least one bitwise operation keys including at least one bitwise operator.

In some embodiments of the non-transitory machine-readable storage medium, the display area shows an operations history. According to some embodiments, the operations history is shown on multiple lines.

According to some embodiments of the non-transitory machine-readable storage medium, the display area is about 96 pixels wide and about 96 pixels high.

According to some embodiments of the non-transitory machine-readable storage medium, the instructions may further include code to: perform a mathematical operation. In some embodiments, the mathematical operation may be a calculation. In some embodiments, the mathematical operation includes at least one of adding, subtracting, multiplying, dividing, AND, OR, XOR, NAND, and modulo.

Yet another specific embodiment relates to a method of performing a type cast. The method may include: accepting input from a set of numerical keys for specifying at least one number and a set of at least one data type key for specifying at least one data type; performing the type cast based on the input; and showing a result of the type cast in a display area.

Some further embodiments of the method include: showing an operations history in the display area. Another further embodiment of the method includes: a third set of buttons including at least one bitwise operator.

According to some embodiments of the method, the first set of buttons has a first color and the second set of buttons has a second color, the first and second colors being different.

In some embodiments of the method, the display area shows an operations history. According to some embodiments, the operations history is shown on multiple lines.

According to some embodiments, the method may further include performing a mathematical operation. In some embodiments, the mathematical operation may be a calculation. In some embodiments, the mathematical operation includes at least one of adding, subtracting, multiplying, dividing, AND, OR, XOR, NAND, and modulo. According to some embodiments, the mathematical operation includes converting from a first data type to a different data type.

### BRIEF DESCRIPTION OF THE DRAWINGS

FIG. 1 is an aerial view of a portable calculator, according to an exemplary embodiment;

FIG. 2 illustrates a system for implementing a method of calculating and displaying numerical data, according to an exemplary embodiment;

FIG. 3 is an illustration of a monitor displaying a calculator application, according to an exemplary embodiment;

FIG. 4 is a flowchart of a method of performing one or more mathematical operations according to a first number base or a different number base, each choice of number base mathematical operations being available simultaneously, according to an exemplary embodiment;

FIG. 5 is a flowchart of a method of performing one or more mathematical operations including a type cast, according to an exemplary embodiment;

FIG. 6 is an illustration of sets of keys and displays for hexadecimal and decimal number input, type cast, and display, according to an exemplary embodiment; and

FIG. 7 is an illustration of a perspective view of a portable dual number base and type cast calculator, according to an exemplary embodiment.

### DETAILED DESCRIPTION OF THE PREFERRED EMBODIMENTS

One or more embodiments described herein may provide dual number base calculators or methods of performing operations in multiple number bases. Workers in technical fields often use two number bases in the performance of their duties. Computers may use base 16 numbers internally, while humans may tend to use base 10 numbers. Thus, software developers often do calculations using base 16 (hexadecimal) and base 10 (decimal) numbers.

Base 16 numbers are usually represented by the numbers 0 through 9 and the letters A through F, such that ‘A’ represents the decimal quantity “10”, and ‘F’ represents the decimal quantity 15. Nevertheless, the distinction between a base 16 number and a base 10 number may not be obvious. If the base 16 number does not contain any of the digits A through F, it may have all the characteristics of a base 10 number but the numerical value would be different. For instance, the base 16 number 1,234 is equal to 4,660 in base 10. Mistakenly using the incorrect number base in arithmetic operations can be the source of many costly errors in technical fields.

Further, as an example, a software developer may be coding a program that uses a memory buffer beginning at address FF80 80A0. The developer may wish to store 200 data blocks of 40 characters each in the memory buffer. The developer may do the calculation, 200 multiplied by 40, using base 10, but then wish to convert the result to base 16. Once the result is converted to base 16, the developer may then add it to the base 16 address, FF80 80A0, to determine the address of the end of the required buffer. This would be accomplished more quickly with a calculator that supports both number bases at the same time.

Various embodiments described herein include a method, calculator, or transitory machine-readable medium to allow for faster, easier, and less error-prone calculations by displaying a number in multiple number bases simultaneously. A different set of input buttons for each base may be displayed simultaneously. Various embodiments are discussed in further detail below. In the above example, for instance, the developer may key in “200×40” using a set of keys dedicated to base 10, which may result in “8000” being displayed in a base 10 display box and “1F40” simultaneously being displayed in a base 16 display box, according to some embodiments.

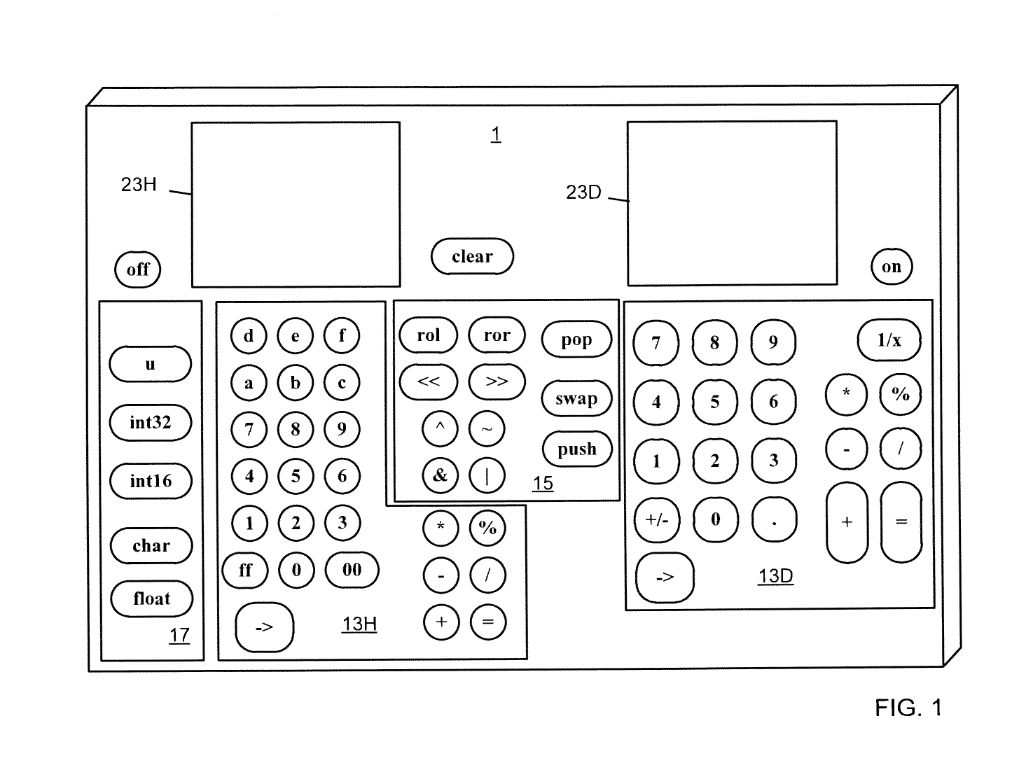

FIG. 1 illustrates a device according to some embodiments of the present invention. As shown in FIG. 1, an exemplary device 1 for implementing process(es) according to some embodiments of the present invention may include, but is not limited to, a calculator. Various embodiments may include hardware devices or program products including computer-readable, non-transient storage media for carrying or having data or data structures stored thereon for carrying out processes as described herein.

A calculator 1 may include an electronic calculator, mechanical calculator, graphing calculator, calculating software such as a software application, scientific calculator, basic calculator, programmable calculator, portable calculator, stationary calculator, or any type of calculator, calculating device, calculating software, combination of any of the above, or the like. According to some embodiments, a device 1 may include a general-purpose computing device such as a computer, special-purpose computer, laptop, tablet computer, mainframe, mobile phone, smartphone, PDA, portable processing device, adding machine, or the like, or any device or system which includes a processor or an arithmetic logic unit (ALU), or is capable of processing or performing a calculation, mathematical operation, number base conversion, or data type cast. A device 1 may include multiple of any of the above types of devices, or a combination of any number of those.

Calculating may include an operation such as add; subtract; multiply; divide; exclusive-or (XOR); bitwise-OR (OR); bitwise-AND (AND); bitwise-NOT (NOT); bitwise-NAND (NAND), bitwise shift-left; bitwise shift-right; bit rotate left (ROL); bit rotate right (ROR); modulo; square root or other root; exponent; pop from a stack, queue, or the like, push to a stack, queue, or the like; swap on a stack, queue, or the like; sine, cosine, tangent, log, natural log, factorial, number base conversion; data type cast; or the like.

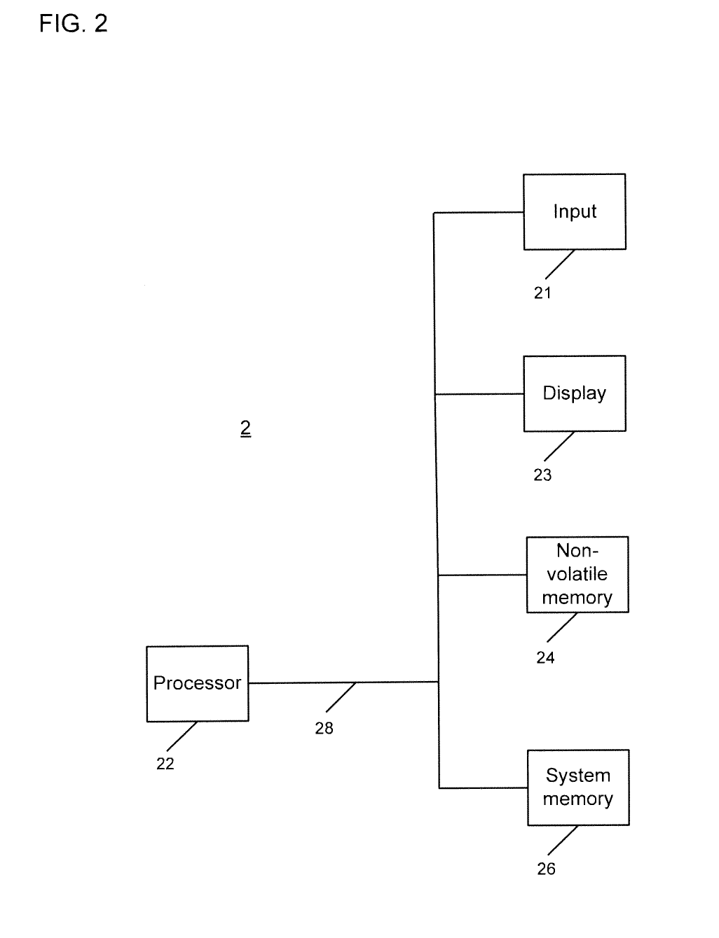

FIG. 2 illustrates a system or a device according to some embodiments of the present invention. As shown in FIG. 2, an exemplary system 2 for implementing the method(s) discussed include (but is not limited to) a general-purpose computing device in the form of a conventional computer or other device 1, which may include a processing unit 22 or processor, a system memory 26 and/or non-volatile memory 24, and a system bus 28 that couples various system components to the processing unit 22. The system may also include input device(s) 21 and/or output device(s) 23.

A processor 22 may be a single processor, an ALU, multiple processors, multiple ALUs, central processing unit, set of processors, distributed set of processors or ALUs, any combination of those, any logic circuitry that responds to and processes instructions, any logic circuitry that performs a calculation, or the like. In some embodiments, the processor 22 is provided by a microprocessor unit. The processor 22 may be a set of circuits for performing calculations or any other processor, circuitry, or the like, capable of operating as described herein.

The system memory 26 may include one or more suitable memory devices such as, but not limited to, RAM. The computer may include a storage medium 24, such as, but not limited to, a solid state storage device and/or a magnetic hard disk drive (HDD) for reading from and writing to a magnetic hard disk, a magnetic disk drive for reading from or writing to a removable magnetic disk, and an optical disk drive for reading from or writing to removable optical disk such as a CD-RW or other optical media, flash memory, etc. The drives and their associated computer-readable media may provide non-transient, non-volatile storage of computer-executable instructions, data structures, program modules, and other data for the computer to function in the manner described herein. Various embodiments employing software implementations may be accomplished with standard programming techniques.

Such non-transient media may be any available media that can be accessed by a device 1. By way of example, such non-transient storage media may include random-access memory (RAM), read-only memory (ROM), erasable programmable read-only memory (EPROM), electrically erasable programmable read-only memory (EEPROM), field programmable gate array (FPGA), flash memory, compact disk, or other optical disk storage, magnetic disk storage or other magnetic storage devices, or any other medium which can be used to carry or store desired program code in the form of computer-executable instructions or data structures and which can be accessed by a device 1. Combinations of the above may also be included within the scope of non-transient media. Volatile computer memory, non-volatile computer memory, and combinations of volatile and non-volatile computer memory may also be included within the scope of non-transient storage media. Computer-executable instructions may include, for example, instructions and data that cause a device 1 to perform a certain function or group of functions.

In addition to a system, various embodiments are described in the general context of methods and/or processes, which may be implemented in some embodiments by a program product including computer-executable instructions, such as program code. These instructions may be executed by computers in networked environments. The terms “method” and “process” are synonymous unless otherwise noted. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

The processor 22 may receive input from one or more input devices 21 or input means 21. An input device 21 may receive input from one or more users or computing devices, and may include (but is not limited to) a keyboard, button or key, set of buttons or keys, a pointing device, e.g., a mouse or a trackball, or a device that senses visual, auditory, or tactile signals (such as a touchscreen), or the like. The terms “button” and “key” may include any type of device that allows a user to make a selection or indication, or a virtual representation of such a device. An input device 21 may be part of a device 1 (as in the case of a laptop, tablet computer, PDA, smartphone, or the like). An input device 21 may be external to a device 1 (as in the case of an external keyboard or mouse). In some embodiments, an input device may be hardware, represented virtually using software, input may be received though a combination of hardware and software, or the like. For example, input may be received through a virtual keyboard (or other input device 21), which is a representation of a keyboard (or other input device 21) that is shown on a display 23.

An input means 21 may be, for example, a numerical input means, a data type input means, or the like. A numerical input means may include any type of input device 21 for inputting information relating to or for the selection or indication of a number or numbers. A data type input means may include any type of input device 21 for inputting information relating to or for the selection or indication of a data type or a data type cast.

The processor 22 may provide output to one or more output devices 23, graphical or numerical displays 23 or graphical or numerical display areas 23 or display areas 23 (herein referred to collectively as “output device”). An output device 23 may provide output to one or more users or computing devices, and may include (but is not limited to) a display such as a CRT (cathode ray tube), LCD (liquid crystal display), LED (light-emitting diode), or plasma monitor or screen. Output devices 23 may include seven-stripe or seven-segment displays, a dot matrix display, vacuum fluorescent display, or the like. A graphical user interface (GUI) may portray a device, and a portion of a GUI display may itself include one or more display areas 23. If, for example, a representation of a calculator is displayed, the displayed “calculator” may appear to have numerical display(s) 23. A display area 23 may be a virtual representation of a hardware display 23. An output device 23 may be part of a device 1 (as in the case of a laptop, tablet computer, PDA, smartphone, portable calculator, or the like). An output device 23 may be external to a device 1 (as in the case of an external monitor or television). In addition, an output device 23 may be any device capable of displaying a number or a representation of a number. Output devices 23 may include networking devices for outputting information to another device 1 through a network interface.

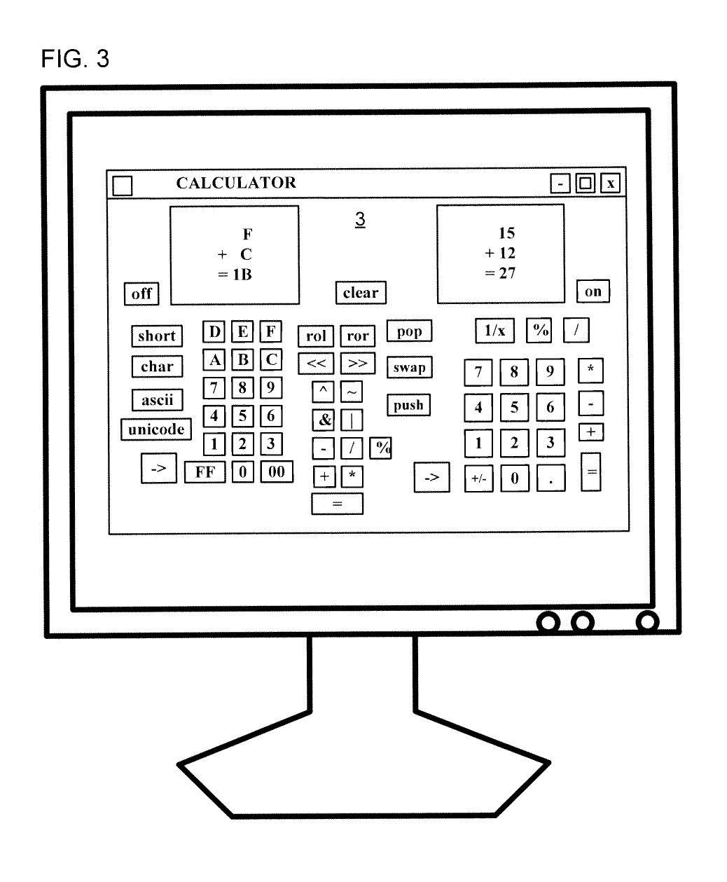

According to some embodiments, computer-executable instructions may encode a process of displaying number base conversions or type casts of calculated numbers. This is illustrated by FIG. 3, which shows a computer monitor displaying a representation of a calculator in a software application window, according to an embodiment of the invention.

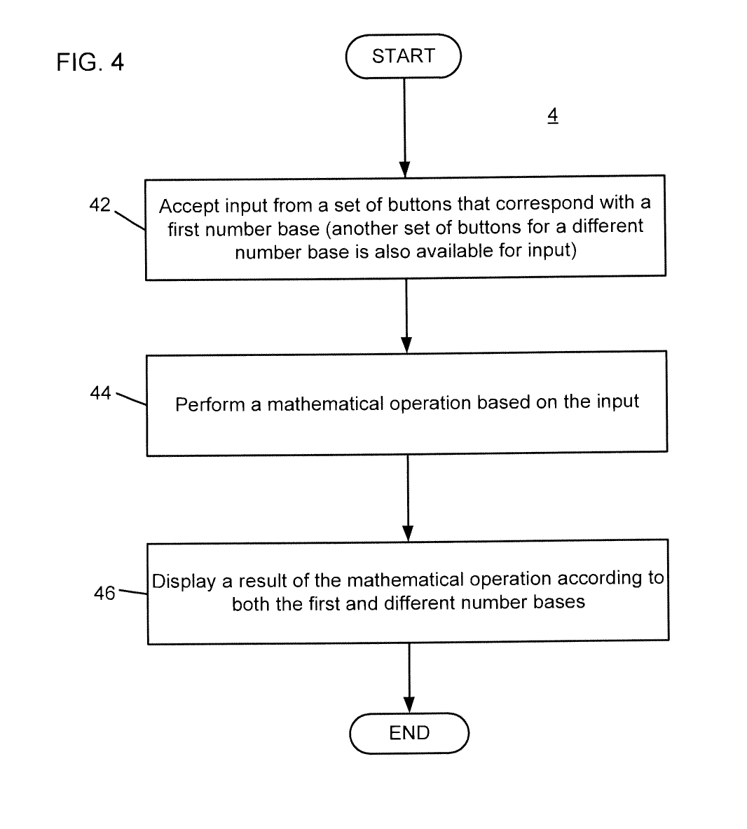

With reference to FIG. 4, a method of performing one or more mathematical operations according to various embodiments may be implemented by a system 2 according to a process 4 as shown in FIG. 4. The method 4 may be implemented using a device 1. The method 4 may be implemented using a processor 22, which may execute instructions to perform the steps of the method 4.

In step 42, input may be accepted, such as from one or more input device(s) 21. A processor 22 may accept input from a user, device, software, or the like. Input from a user or device may include input from a mouse used to hover over, click on, drag, etc., to indicate a number. Input from a user or device may instead be from a keyboard, such as from the pressing of one or more keys, buttons, or the like. Input from a user or device may be a result from the touching or dragging of fingers on a touchscreen device. Input from a user or device may be a result from a verbal command, a visual command (such as, but not limited to, from a light sensor, including an infrared sensor receiving a signal from a device such as a remote).

Input may be received from a set of one or more buttons, keys, or the like, that correspond with a number base. The terms “buttons” and “keys” are used interchangeably herein. Examples of sets 13 of buttons are depicted in FIG. 1, according to an embodiment. The set 13 may be implemented in hardware and/or software. The set 13 may be a physical set of buttons, keys, or the like, or anything that a user may press or otherwise use to physically indicate a selection. The set of buttons or keys may be a virtual representation of buttons, keys, or anything else that may indicate a user's input intention. For example, as illustrated in FIG. 3, a software application may cause a display 23 to display image(s) that may be selected by a user as input.

There may be more than one set 13 available for accepting input. Two or more sets 13 may correspond with different number bases. For example, as illustrated in FIG. 1, a set 13H is available for inputting hexadecimal number input, while a set 13D is available for inputting decimal number input. Although two sets are illustrated in FIG. 1, more (or different) sets 13 may be available for input in other embodiments. A set 13 may correspond with any number base, including, but not limited to, base 2 (binary), base 8 (octal), base 10, base 12, base 16, base 60, base 64, base 256, or the like. Sets 13 may each be a different color. For instance, still referring to FIG. 1, set 13H may have blue buttons, while set 13D may have yellow buttons. Alternatively, the colors of the buttons of sets may be the same, while the surrounding backgrounds may be different.

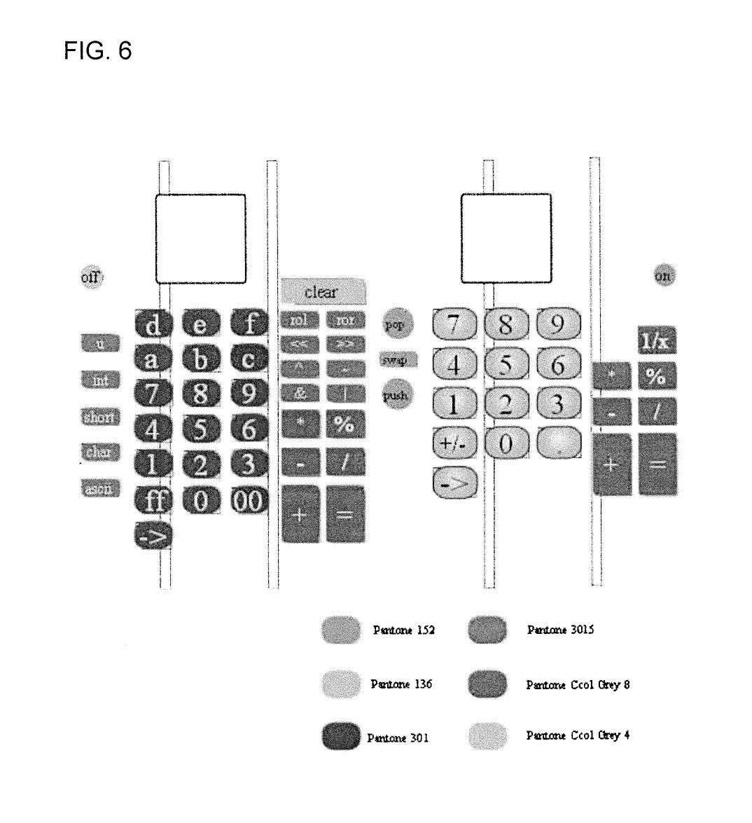

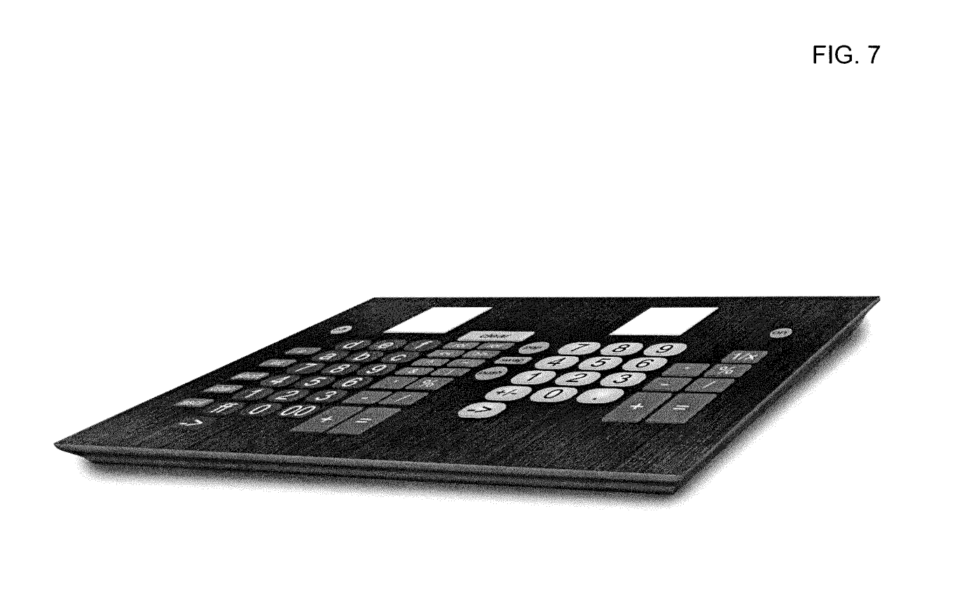

In some embodiments, a calculator may have different portions or sides that are each dedicated to a number base, including a block of keys. For instance, FIG. 6 illustrates an exemplary embodiment in which the side on the left is dedicated to one number base, hexadecimal, while the side on the right is dedicated to another number base, decimal. As shown in exemplary embodiment of a portable calculator illustrated in FIG. 7, the different sides that are dedicated to number bases may be on the same face of the calculator. A side that is dedicated to a number base may not be the same side as another side dedicated to a different number base.

Sets 13 may be simultaneously visible or simultaneously available for input. This is also illustrated in FIG. 1, which shows that set 13H and set 13D are both included in the calculator 1. Similarly, FIG. 3 shows that two sets 13 are simultaneously visible on the display in the calculator software application window. In various embodiments, sets 13 are simultaneously available for input when they are both visible or accessible as input. For example, if a user must specify (such as with a radio button or checkbox) which number base or set 13 is to be used, rather than the indication being implied by using one set 13 over the other(s), the sets 13 may not be simultaneously available for input. The sets 13 may be available for input at the same time without requiring any action from an operator. Switching from one type of number base input to another, may be done by switching from the use of one set 13 to another set 13. This switch may be done without selecting a radio button, checkbox, or the like, other than to use a set 13 instead of one or more other sets 13.

“Simultaneously” as used herein may mean simultaneous or near simultaneous. “Simultaneously” and “at the same time” are used interchangeably herein.

In some embodiments, a user may begin entering input using one set 13, which may cause input to be disabled or ignored from another set 13. In this case, the sets 13 are still considered “simultaneously available for input” because the sets 13 were simultaneously available at the time that (or before) the user began entering input. The disabling or ignoring feature may be temporary, until a number is completely entered or a mathematical operation is complete.

Input may include numerical data from set(s) 13, operators from set(s) 13, operators 15 not included in a set 13, data type operators 17, or the like. Operators 13, 15 may include those related to addition; subtraction; multiplication; division; exclusive-or; bitwise-OR; bitwise-AND; bitwise-NOT; bitwise-NAND, bitwise shift-left; bitwise shift-right; bit rotate left (ROL); bit rotate right (ROR); modulo; square root or other root; exponent; pop from a stack, queue, or the like, push to a stack, queue, or the like; swap on a stack, queue, or the like; number base conversion; sine, cosine, tangent, log, natural log, factorial, or the like.

A history of input may be stored in memory 24, 26. Some or all of the history may be displayed on one or more displays 23. For example, FIG. 3 illustrates an example in which a history is displayed in a display 23D according to base 10. The user had entered the decimal number 15, a plus sign, a decimal number 12, and an equals sign. According to some embodiments, the history may be displayed according to multiple number bases. This is illustrated in FIG. 3, which shows the hexadecimal conversion of the history in a display 23H, where “F+C=” is displayed. One or more results may be included in a history. A history may include only results, it may include results and select the input numbers and operators, or it may include results and all of the input numbers and operators that were necessary for the results. A history may be displayed on multiple lines, displayed in a scrolling fashion, it may be cut off on the display, it may be stored in memory and shown on demand, or the like.

Referring again to FIG. 4, in step 44, a mathematical operation may be performed, based on the input received in step 42. The mathematical operation may involve one or more numbers input in step 42. The mathematical operation may involve one or more operators input in step 42. The mathematical operation may be performed by calculation circuitry or a processor 22. The mathematical operation may be a calculation.

In step 46, a result of the mathematical operation of step 44 may be displayed. A processor 22 may execute instructions that instruct at least one output device 23 to display a result. In various embodiments, a number or any representation of a number is displayed on display(s) 23 or other output device(s) 23.

The result may be displayed according to multiple number bases. A result according to one base may be displayed simultaneously with a result according to one or more different bases. For example, FIG. 3 illustrates an example of a result of a mathematical operation that is displayed in two displays 23 according to decimal (“27”) and according to hexadecimal (“1”). The displayed result for one base may be the equivalent of the result(s) displayed according to different base(s).

A result may be simultaneously displayed on the multiple displays 23 automatically upon completion of a calculation.

Displays 23 may be horizontally aligned. An example is shown in FIG. 1, in which 23H and 23D are horizontally aligned. Displays 23 may be horizontally aligned when they are in an intended viewing position. In some embodiments, they are horizontally aligned when they are facing the user. For instance, FIG. 3 illustrates a calculator on a monitor, such that the graphical or numerical display areas within the calculator application are horizontally aligned when the monitor is facing the user as intended. According to some embodiments, a hexadecimal display is on the left while a decimal display is on the right, as illustrated by 23H and 23D of FIG. 1.

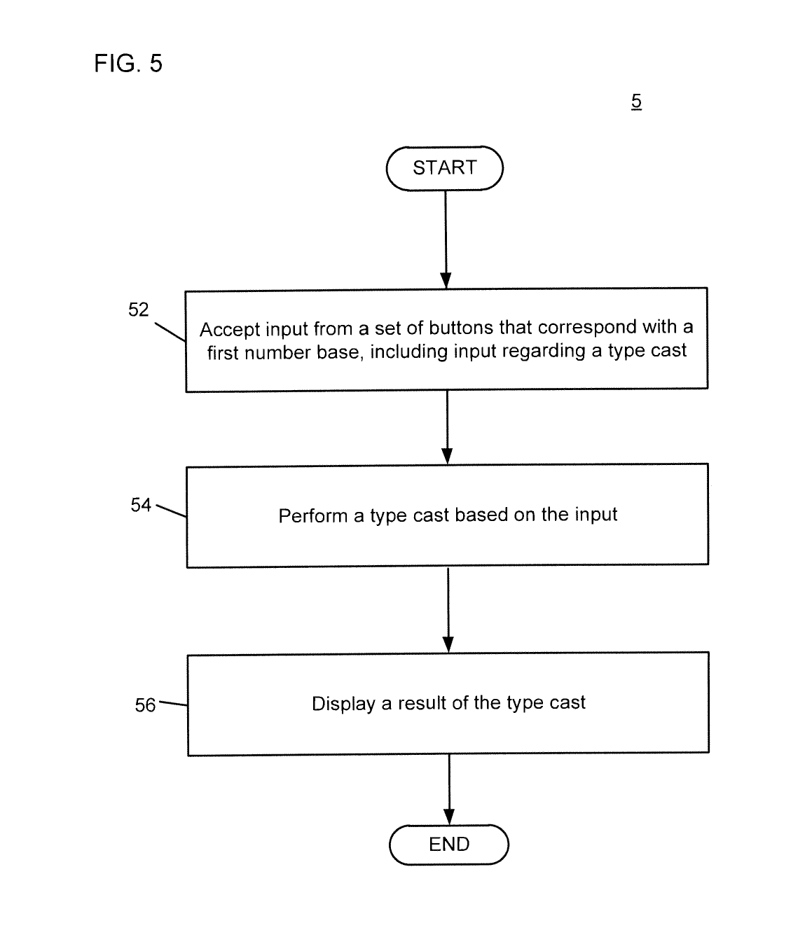

With reference to FIG. 5, a method of performing a type cast according to various embodiments may be implemented by a system 2 according to a process 5 as shown in FIG. 5. The method 5 may be implemented using a device 1. The method 4 may be implemented using a processor 22, which may execute instructions to perform the steps of the method 5.

In step 52, input may be accepted. Input may be received in a manner similar to that described above in relation to step 42 of the method 4. In some embodiments, a data type may be accepted for one or more input numbers. In some embodiments, there may be a default data type. The default data type may be changed according to input. Data type operators 17 that may be input as part of step 52 may include those related to any data type such as boolean, flag, byte, octet, nibble, semioctet, integer, short, word, double, doubleword, bigint, BigInteger, long, longword, long long, quad, quadword, int64, octaword, double quadword, floating point, char, widechar, ASCII, Unicode, UTF-8, UTF-16, unsigned (U) or signed versions of any data type, or the like.

In step 54, a type cast may be performed, based on the input received in step 52. A mathematical operation may be performed, based on the input received in step 52. The calculation may involve one or more operators input in step 52. The mathematical operation may be performed by calculation circuitry or a processor 22. The mathematical operation may include converting from a first data type to a different data type. The mathematical operation may include a combination of a data type cast and performing another operation according to at least one input operator specified in step 52. The mathematical operation may be a calculation.

In step 56, a result of a type cast may be displayed. It may be displayed in one or more displays 23 or other output devices 23. A result of a mathematical operation or calculation may be displayed.

Displaying the result of a type cast is beneficial because it can help a software developer avoid mistakes and confusion while writing and debugging software code. Converting from one type to another can create a result that the developer was not expecting. It is useful to have a calculator that does the same conversion as the software code does, to help the developer avoid mistakes in the software code.

By prefacing a mathematical operation by its data type, the developer can determine that there are equation errors while programming the equation rather than waiting for the program to fail during testing. For example, suppose the developer is using a 16-bit signed variable (short) which is exceeding the maximum value for that data type (overflowing) in a certain instance, so that the variable is incorrectly set to a negative number. The developer may be able to debug this error by entering the program's calculation steps in a data type-casting calculator, so that it is more visible to the developer that the variable becomes negative.

As another example, suppose a software developer is encrypting a password using the rotate instruction, such that bits that shift off the left side are reintroduced on the right side. Viewing the variable as the same data type as the compiler views it allows the developer to mirror, step by step, the way the encryption routine will run in the host computer. Specifying unsigned numbers is also useful, eliminating the overhead of the sign bit when an input number is expected to not be negative.

According to some preferred embodiments, a calculator may have dimensions of about 160 mm by about 120 mm. A representation of a calculator or calculating device on a display may have default dimensions of about 160 mm long by about 120 mm wide. At least some of the keys or buttons may each have dimensions of about 10 mm by about 13 mm. In some preferred embodiments, the displays 23 of a calculator as displayed on a monitor 23 may each be about 96 pixels wide and about 96 pixels high.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein.

The above-described embodiments can be implemented using hardware, software or a combination thereof. The various methods or processes outlined herein may be coded and executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, some inventive concepts may be embodied as a computer readable storage medium (or multiple computer readable storage media) encoded with one or more programs that, when executed on one or more computers or other processors, perform methods that implement the various embodiments of the invention discussed above. The computer-readable medium or media can be transportable, such that the program or programs stored thereon can be loaded onto one or more different computers or other processors to implement various aspects of the present invention as discussed above. The recitation of a module, logic, unit, or circuit configured to perform a function includes discrete electronic and/or programmed microprocessor portions configured to carry out the functions. For example, different modules or unit that perform functions may be embodied as portions of memory and/or a microprocessor programmed to perform the functions.

Additionally, it should be appreciated that according to one aspect, one or more computer programs that, when executed, perform methods of the present invention, need not reside on a single computer or processor, but may be distributed in a modular fashion amongst a number of different computers or processors to implement various aspects of the present invention.

The indefinite articles “a” and “an,” as used herein in the specification and in the claims, unless clearly indicated to the contrary, should be understood to mean “at least one.”

While specific embodiments have been disclosed, the various embodiments are not to be considered limiting. One of ordinary skill in the art will understand that variations and modifications flow from the teachings provided herein.

What is claimed is:

1. A dual number base calculator comprising:
a first graphical or numerical display;
a second graphical or numerical display;
a first block of keys for accepting input according to a first number base;
a second block of keys for accepting input according to a different number base, in which the first and second blocks of keys are available for input at the same time; and
a processor for performing a mathematical operation based on input from the first and second blocks of keys, the processor configured to show a result on the first graphical or numerical display at the same time as on the second graphical or numerical display, the result shown on the first graphical or numerical display according to the first number base and on the second graphical or numerical display according to the different number base.

2. The calculator of claim 1 in which the first and second blocks of keys are available for input at the same time without requiring any action from an operator.

3. The calculator of claim 1 further comprising a third block of keys including at least one bitwise operator.

4. The calculator of claim 1 in which the first block of keys has a first color and the second block of keys has a second color, the first and second colors being different.

5. The calculator of claim 1 in which the first and second graphical or numerical displays show an operations history in the first number base and the different number base, respectively.

6. The calculator of claim 1 in which the first and second displays are horizontally aligned.

7. The calculator of claim 1 in which the result is shown on the first and second graphical or numerical displays at the same time automatically upon completion of the mathematical operation.

8. The calculator of claim 1 which measures about 160 mm long by about 120 mm wide.

9. The calculator of claim 1 in which the mathematical operation comprises converting from a first data type to a different data type.

10. A non-transitory machine-readable storage medium encoded with instructions for showing number base conversions of calculated numbers, the instructions comprising code for:
accepting input from a first set of keys according to a first number base or from a second set of keys according to a different number base, in which the first and second sets of keys are available for input at the same time;
performing a mathematical operation based on the input; and
showing a result of the mathematical operation according to the first number base on a first display area, while showing an equivalent result at the same time, according to the different number base on a second display area.

11. The non-transitory machine-readable storage medium of claim 10 in which the first and second display areas are horizontally aligned.

12. The non-transitory machine-readable storage medium of claim 10 in which the first set of keys has a first color and the second set of keys has a second color, the first and second colors being different.

13. The non-transitory machine-readable storage medium of claim 10 in which the first and second display areas show an operations history in the first number base and the different number base, respectively.

14. The non-transitory machine-readable storage medium of claim 10 in which the results are shown on the first and second display areas at the same time automatically upon completion of the mathematical operation.

15. The non-transitory machine-readable storage medium of claim 10 in which first and second display areas are each about 96 pixels wide by about 96 pixels high.

16. The non-transitory machine-readable storage medium of claim 10 in which the mathematical operation comprises converting from a first data type to a different data type.

17. A method of performing a mathematical operation according to a first number base or a different number base, comprising:
accepting input from a first set of buttons according to the first number base or from a second set of buttons according to the different number base, in which the first and second sets of buttons are available for input at the same time;
performing the mathematical operation; and
showing a result of the mathematical operation in a first graphical or numerical display area and a second graphical or numerical display area at the same time, the first display area showing the result according to the first number base and the second display area showing an equivalent result according to the different number base.

18. The method of claim 17, further comprising:
showing a first operations history in the first number base and a second operations history in the different number base.

19. The method of claim 17 in which the result is shown on the first and second display areas at the same time automatically upon completion of the mathematical operation.

20. The method of claim 17 in which the mathematical operation comprises converting from a first data type to a different data type.

21. A type-casting calculator, comprising:
a graphical or numerical display;
a block of numerical keys for specifying at least one number;
a block of at least one data type key for specifying at least one data type;
a processor for performing a type cast based on input from the block of numerical keys and the block of at least one data type key, in which the processor is configured to display a result of the type cast on the graphical or numerical display.

22. A non-transitory machine-readable storage medium encoded with instructions for showing a type cast of a number, the instructions comprising code for:
accepting input from a set of numerical keys for specifying at least one number and a set of at least one data type key for specifying at least one data type;
performing the type cast based on the input; and
showing a result of the type cast in a display area.

23. A method of performing a type cast, comprising:
accepting input from a set of numerical keys for specifying at least one number and a set of at least one data type key for specifying at least one data type;
performing the type cast based on the input; and
showing a result of the type cast in a display area.
